(19) United States
(12) Patent Application Publication
(10) Pub. No.: US 2004/0047319 A1
(43) Pub. Date: Mar. 11, 2004

(54) Contention-based medium access control for ad hoc wireless piconets

(76) Inventor: Johannes Elg, Helsingborg (SE)

Correspondence Address: BURNS DOANE SWECKER & MATHIS L L P, POST OFFICE BOX 1404, ALEXANDRIA, VA, 22313-1404, US

(21) Appl. No.: 10/235,801

(22) Filed: Sep. 6, 2002

(51) Int. Cl. H04Q 7/24; H04J 3/16

(52) U.S. Cl. 370/338; 370/345

(57) ABSTRACT

A communication medium is accessed by a present communication unit in a communications system, wherein the communication medium comprises a plurality of successively occurring time slots. This involves determining whether a present time slot is a contention priority slot. If the present time slot is a contention priority slot, then a contention-based medium access control protocol is used to access the communication medium. If the present time slot is not a contention priority slot, then a non-contention-based medium access control protocol is used to access the communication medium.

### BACKGROUND

This invention relates to communications networks. More particularly, it relates to medium access control in a communications network.

Radio Local Area Networks (LAN) typically constitute an area of technology where the computer industry and the wireless communications industry merge. Conventional computer networking has relied on wired LANs, typically packet-switched and targeted for data transfer. By contrast, wireless networking, and in particular cellular networking, has relied on wide area networks, typically circuit-switched and targeted for voice transfer. Most efforts in the design of radio LANs have reused the principles that are used in wired LANs. This, however, is a questionable procedure because the environments of the wired medium and of the wireless medium differ in important ways. Moreover, multimedia communications require additional features due to the special traffic characteristics posed by data, voice and video. Finally, the residential environment has its own requirements, which can be decisive for the design of the system. Almost one hundred percent of the computer networks today use a wired infrastructure. The wired medium can range from a simple twisted pair to an optical fiber. Due to its shielded and controllable environment, the wired medium is characterized by low interference levels and stable propagation conditions. Consequently, the wired medium has potential for high to very high data rates. Because of the latter, all participants in wired LANs typically share this single medium. The medium constitutes a single channel, which is used by only a single one of a number of different users at any given time. Time-division multiplexing (TDM) is used to allow different users to access the channel at different times. The protocols for accessing wired media have been standardized by the IEEE in its 802 series. Typically, multiple access reservation techniques like carrier-sensing (e.g., Ethernet, 802.3 Carrier-Sense Multiple Access/Collision Detect (CSMA/CD)) or tokens (e.g., 802.4 token buses, or 802.5 token rings) are used to gain access to the medium. These protocols can be used in a distributed sense in that the user occupying the channel reserves the medium by its present transmission or by its token. In these schemes, every user can hear all traffic. That is, in a single LAN, all users share not only the channel, but also all of the information carried on that channel. When the number of participants grows, the LAN can be divided into smaller LANs or segments, which channels operate independently. LANs can be interconnected via bridges or routers, which form interfaces between the different local networks. These configurations result in more complex networks. For examples of this background information, reference is made to D. Bertsekas and R. Callager, Data Networks, 2^{nd} Edition, Prentice-Hall, London, 1992. For the discussion of the residential LANs, it suffices to consider the single LAN. The LAN typically provides a connectionless packet-switched service. Each packet has a destination address (and usually a source address as well) so that each user can determine whether the packet that passes by is intended for him or not. It will be understood that the net throughput per user in a single LAN is determined by the peak data rate on the channel and by the number of users that share this channel. Even if the peak data rate is very high due to the wide bandwidth of the wireline medium, the effective user throughput can be low if the channel has to be shared among many users.

Since the type of communication that takes place over current wired LANs is asynchronous and connectionless, it is ill suited for supporting delay-critical services like voice. Voice services demand synchronous or isochronous connections, which require priority techniques in the Medium Access Control (MAC) protocols in order to give voice users precedence over non-voice users. Different studies in existing data networks have shown that this is not a trivial task. During the last several years, standards bodies in the United States and in Europe have worked on wireless LANs (WLANs). In the United States, this has resulted in the IEEE 802.11 standard (Draft standard IEEE 802.11, P802.11/D1, December 1994), whereas in Europe this has resulted in the ETSI HIPERLAN standard (ETSI, RES10/96/etr, “Radio Equipment and Systems (RES); High Performance Radio Local Area Networks (HIPERLANs), July 1996). Looking first at the IEEE 802.11 standard, as the name indicates, it is an extension of the 802 LAN standard. The wireless connection is either a radio link or an infrared link. The radio medium is the Industrial, Scientific, Medical (ISM) band at 2.4 GHz. However, for a single radioLAN, only a 1-2 Mb/s channel is available at any given time. This relatively narrow channel has to be shared among all participants of the radio network. Both a configuration based on a wired infrastructure and a configuration based on an ad-hoc structure have been defined. With a wired infrastructure, the radio system merely provides a wireless extension between the wired LAN and the user terminal. Fixed access points interface between the wireline domain and wireless domain. In an ad-hoc network, wireless units create their own wireless network. No wired backbone is involved at all. It is the ad-hoc nature provided with wireless communication that gives the WLANs an important advantage over wired LANs in certain applications.

To avoid interference with other networks or other applications in the 2.4 GHz ISM band, either direct-sequence spreading or slow frequency hopping is used. Access to the channel is accomplished by a special form of Carrier-Sense Multiple Access/Collision Avoidance (CSMA/CA) that provides a connectionless service. In an architecture based on a wired infrastructure, the fixed part takes the role of a central controller, which schedules all traffic. In an ad-hoc architecture, the distributed CSMA/CA protocol provides the multiple access to the channel. All in all, the IEEE 802.11 standard is very similar to that of the wired Ethernet, with the wire being replaced by a 1 Mb/s radio channel. It will be understood that the effective user throughput decreases quickly when the number of participants increases. In addition, since the spreading factor for Direct Sequence Spread Spectrum (DSSS) is only 11 and the hop rate for Frequency Hopping Spread Spectrum (FHSS) is only on the order of 10 to 20 hops/s, little immunity is provided against interference in the ISM band. Different networks can theoretically coexist in the same area (different networks either use different DSSS carrier frequencies of which seven are defined, or use different FHSS hop sequences), thereby increasing the aggregate throughput. In fact, in A. Kamerman, “Spread-Spectrum Techniques Drive WLAN Performance,” Microwaves &: RF, September 1996, pp. 109-114, it was claimed that the aggregate throughput, defined as the average throughput per user times the number of collocated users (not necessarily participating in the same network), can never exceed 4-6 Mb/s with either technology. For collocating different networks under the IEEE 802.11 standard it is preferred that the networks be based on a wired infrastructure: a limited number of collocated fixed access points can create their own network. A certain amount of coordination via the wired network is then possible. However, for networks based on an ad-hoc structure, this is much more difficult under IEEE 802.11 because the MAC protocol does not lend itself to this creation. Instead, units that come in range of an ad-hoc network will join an existing network and not create their own network.

HIPERLAN has followed a path similar to that of IEEE 802.11. The system operates in the 5.2 GHz band (not available in the United States). The standard is still under development and consists of a family of sub-standards, HIPERLAN 1 to 4. The most basic part, HIPERLAN 1 (ETSI, ETS300652, “Radio Equipment and Systems (RES); High Performance Radio Local Area Networks (HIPERLAN) Type 1; “Functional Specification”, June 1996), is similar to the IEEE 802.11 standard. Again, a single channel is used, but with a higher peak data rate of 23.5 Mb/s. A dedicated CSMA/CA scheme is used, called Elimination-Yield Non-Preemptive Priority Multiple Access (EY-NPMA) which provides a number of contention-based phases before the channel is reserved. Although the 5.2 GHz band is unlicenced in Europe, only HIPERLAN-type applications are allowed. Therefore, no special measures against unknown jammers are implemented. Different networks can coexist in the same area provided different 23 MHZ wide channels are used. Out of the 5.2 GHz, five such channels have been defined. One other interesting activity in the HIPERLAN area is the HIPERLAN 2 standardization, which concentrates on wireless Asynchronous Transfer Mode (ATM). Presumably, this wireless network will also use the 5.2 GHz band, will support peak data rates exceeding 40 Mb/s, and will use a centralized access scheme with some kind of demand assignment MAC scheme.

What the existing WLAN systems have in common with the wired LANs is that a single channel is shared among all the participants of the local network. All users share both the medium itself and all information carried over this medium. In the wired LAN, this channel encompasses the entire medium. However, this is not so in the radioLANs. In the radioLANs, the radio medium typically has a bandwidth of 80 to 100 MHZ. Due to implementation limitations and cost of the radio transceivers, and due to restrictions placed by regulatory bodies like the FCC and ETSI, it is virtually impossible to define a radio channel in the radioLAN with the same bandwidth as the radio medium. Therefore, only part of the radio medium is used in a single LAN. As a result, the peak data rate over the channel decreases. But more importantly, the effective user throughput decreases because all participants share this channel, which is now much smaller than the medium. Although the medium is divided into different channels, each of which can be used to set up a different radioLAN, in practice, only a single network covers a certain area, especially when it concerns ad-hoc networks. In radioLANs based on a wired infrastructure, the different channels can be used to create cells, each cell with its own network that is not or minimally disturbed by neighboring cells. This result is achieved at the expense of effort in planning the allocation of channels. In this way, a cellular structure is created that is similar to those encountered in cellular mobile systems. The use of different ad-hoc radio networks in the same cell, however, is prohibited, thereby limiting the attainable aggregate throughput per unit area.

Ad-hoc networks, by definition, do not rely on the support of a wired infrastructure as is commonly applied in cellular, cordless and WLAN systems. In the latter systems, access to the wired backbone is accomplished by access points or base stations. These base stations broadcast known control signals to which the portable terminals can lock. Via the control signals, incoming and outgoing calls can be established and terminals can be directed to dedicated traffic channels. In conventional wireless systems, the activities of the base stations are highly coordinated. In ad-hoc systems, the situation is completely different. Since ad-hoc systems are based on peer-to-peer connectivity, there is no difference between base stations and terminals. Terminals could of course start to operate as base stations in order to facilitate connection establishment. However, in a peer environment, it is unclear which unit should be base station, when and for how long. It is very undesirable to have each radio unit broadcast control information because it is not at all certain whether other units are around to receive this information. In addition, it consumes valuable (battery) power and creates unnecessary interference.

A system called a BLUETOOTH™ system was recently introduced to provide ad-hoc connectivity between portable devices like mobile phones, laptops, PDAs, and other nomadic devices. This system applies frequency hopping to enable the construction of low-power, low-cost radios with a small footprint. The system supports both data and voice communication. The latter is optimized by applying fast frequency hopping with a nominal rate of 800 hops/s through the entire 2.4 GHz ISM band in combination with a robust voice coding. Automatic retransmission is applied on data packets to combat packet failures due to collisions between different piconets visiting the same hop channel. Devices based on the BLUETOOTH™ system concept can create so called piconets, which consist of a master device, and one or more slave devices connected via the FH piconet channel. The FH sequence used for the piconet channel is completely determined by the address or identity of the device acting as the master. The system clock of the master device determines the phase in the hopping sequence. In the BLUETOOTH™ system, each device has a free-running system clock. The slave devices add a time offset to their clocks such that they become aligned with the clock of the master device. By using the master address to select the proper hopping sequence and by using the time offset to align to the master clock, the slave devices keep in hop synchrony to the master device; that is, master and slave devices remain in contact by hopping synchronously to the same hop frequency or hop carrier. For more details, the reader is referred to U.S. patent application entitled “FH piconets in an uncoordinated wireless multi-user system,” by J. C. Haartsen, U.S. patent application Ser. No. 08/932,911 filed on Sep. 18, 1997, which is hereby incorporated herein by reference in its entirety.

In order to provide both low-priority asynchronous services as well as high-priority synchronous services, in original BLUETOOTH™ systems, all information transfer is controlled by the master. The master and slaves alternatively transmit and receive radio packets in a Time Division Duplex (TDD) fashion. To prevent two or more slaves from transmitting simultaneously, which would result in a packet collision and packet failure at the master receiver, the master for each packet assigns the slave that is allowed to transmit. With this polling procedure, the master can prioritize traffic flows and can allocate bandwidths between the slaves efficiently. All traffic is contention free. Polling is achieved by the rule that a slave is only allowed to transmit in the current slave-to-master slot when it has received a packet from the master in the master-to-slave slot directly preceding the current slave-to-master slot. Each packet contains a slave address with which the master addresses the slave. If the master has something to transfer to the slave, the master packet will contain a payload with slave information. This type of packet is referred to throughout this disclosure as an implicit poll and the act of sending it is called “implicitly polling”, since receipt of this packet allows the slave to respond. If the master has no information to send to the slave, it occasionally has to send a packet without a payload to the slave, just to enable the slave to send something to the master. This packet without a payload serves as a poll packet explicitly polling the slave, and the act of sending such a packet is referred to throughout the disclosure as “explicitly polling”. The polling procedure used by the master determines the bandwidth allocation given to the slaves: when a slave is polled more often, it receives more bandwidth.

In the past, several polling schemes have been considered. Round-robin schemes, in which the master consecutively polls the slaves, is optimal when the throughput and latency requirements between the slaves are uniform. Descriptions of round-robin methods can be found in “Exact Analysis of round-robin scheduling of services,” by Hodeaki Takagi, IBM J. Rs. Dev. 31, 4 (July), pp 484-488, and in “Queuing Analysis of Polling Models,” by Hodeaki Takagi, ACM Computing Surveys, Vol. 20, No. 1, March 1988. To dynamically adjust to traffic offering, exhaustive polling can be applied which means that once a slave is allowed to start transmission, it will keep sending packets until its queue is empty. Only then will the master progress to the next slave. Combinations of round-robin and exhaustive polling have been described in “Performance Evaluation of Scheduling Algorithms for Bluetooth,” by N. Johansson et al., Proc. of IFIP TC6, 5^{th} Int'l. Conf. On Broadband Communication 1999, Hong Kong, Nov. 10-12, 1999; such combinations are denoted as fair exhaustive polling. Polling schemes so far have taken into account desired throughput, and offered load. However, they have not properly addressed latency and service priority.

More recently, newer polling strategies have been proposed, such as those disclosed in U.S. application Ser. No. 10/079,572 (Atty Dkt. No. 040071-605: Jacobus C. Haartsen, “Dynamic Bandwidth Allocation in Ad Hoc Wireless Piconets,” filed Feb. 22, 2002) and in U.S. application Ser. No. 10/114,072 (Atty Dkt. No. 040071-692: Jacobus C. Haartsen, “Method and Apparatus for Token Distribution,” filed Apr. 3, 2002), both of which are hereby incorporated herein by reference in their entireties. In each of these, strategies involving the assignment, to each participating unit, of a relative priority level and a desired polling interval are used. In the “Dynamic Bandwidth Allocation . . . ” document, it is the master unit that utilizes this strategy to determine which slave to address in a next transmission. In the “ . . . Token Distribution” document, the techniques are extended to cover ad hoc piconets that do not require that units be designated as either master or slave; rather, each token-possessing unit may pass the token to any of the other participating units, with selection being determined in accordance with the disclosed polling strategies.

It has been additionally proposed to superimpose a “priority transmission” strategy on top of the token-passing strategy outlined above. Essentially, predetermined ones of the slots would be preallocated to particular ones of the units, such that whenever one of the so-called “priority slots” occurs, only the owner of that particular priority slot has the right to transmit, regardless of who last owned the token. The use of priority slots is useful to achieve:

Quality-of-Service

Lower power modes

Bandwidth allocation

Master support for low speed slaves

Multicast support

In addition, priority slots are useful for reintroducing a token after one has been “lost”. (A token can become “lost”, for example, when the intended recipient of a token does not hear the token-passing transmission.) By directing a transmission to a particular recipient, the priority slot-owning unit effectively passes a new token to that unit. For optimal performance, it has been proposed that the intervals between priority time slots be the same for all units, but that the priority time slots be staggered from one unit to the next.

The variously described techniques suffer from a number of drawbacks. For example, in best effort data communications, it is difficult to know how to set the various parameters in the scheduling/polling algorithm. A bad parameter setting can have a serious negative effect. Moreover, the scheduling/polling algorithm presents added complexity. Also, a signaling-based solution may come at the expense of a very high overhead, and is not suitable for data applications which cannot make accurate predictions about their traffic requirements.

### SUMMARY

There is, therefore, a need for media access control methods and apparatuses that provide one or more of the following:

simplification of upper layers of the communications protocol (and in the end, simplification of the total system);

optimization of TCP/IP support; and

improved robustness and ad-hoc functionality.

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, one or more of the foregoing and other objects are achieved in methods and apparatuses that enable accessing of a communication medium by a present communication unit in a communications system, wherein the communication medium comprises a plurality of successively occurring time slots. This involves determining whether a present time slot is a contention priority slot. If the present time slot is a contention priority slot, then a contention-based medium access control protocol is used to access the communication medium. If the present time slot is not a contention priority slot, then a non-contention-based medium access control protocol is used to access the communication medium.

### BRIEF DESCRIPTION OF THE DRAWINGS

The objects and advantages of the invention will be understood by reading the following detailed description in conjunction-with the drawings in which:

FIG. 1 depicts a star configuration between a master and several slaves;

FIG. 2 depicts the flow of information in a frequency hopping/time-division duplex channel;

FIG. 3 depicts a known packet format in a BLUETOOTH™ system;

FIG. 4 is a timing diagram showing a typical polling strategy as implemented in a BLUETOOTH™ system;

FIG. 5 is a timing diagram that illustrates the overall behavior of an exemplary system in accordance with the invention;

FIG. 6 is a high-level flowchart of processes carried out in each communication unit operating within the system;

FIG. 7 is a flowchart of steps carried out in a contention-based mode of communication, in accordance with an aspect of the invention; and

FIG. 8 is a flowchart of steps carried out in an alternative embodiment of a contention-based mode of communication, in accordance with an aspect of the invention.

### DETAILED DESCRIPTION

The various features of the invention will now be described with reference to the figures, in which like parts are identified with the same reference characters.

The various aspects of the invention will now be described in greater detail in connection with a number of exemplary embodiments. To facilitate an understanding of the invention, many aspects of the invention are described in terms of sequences of actions to be performed by elements of a computer system. It will be recognized that in each of the embodiments, the various actions could be performed by specialized circuits (e.g., discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

In exemplary embodiments described herein, the system is based on the FH radio air interface as described in U.S. application Ser. No. 08/685,069 entitled “Short-range radio communications system and method of use,” by P. W. Dent and J. C. Haartsen, filed Jul. 23, 1996, and on the method of channel access described in U.S. Pat. No. 5,940,431 entitled “Access technique of channel hopping communications system,” by J. C. Haartsen and P. W. Dent, granted Aug. 17, 1999. The concepts of connectivity for devices using this air interface are further described in U.S. application Ser. No. 08/932,911 entitled “FH piconets in an uncoordinated wireless multi-use system.” by J. C. Haartsen, filed Sep. 18, 1997, and in U.S. application Ser. No. 08/932,244 entitled “Contemporaneous connectivity to multiple piconets” by J. C. Haartsen, filed Sep. 18, 1997. The mentioned air interface has been the foundation for the BLUETOOTH™ air interface, described in the “Specification of the Bluetooth system,” v 1.0 draft foundation, Jul. 5, 1999 (henceforth, “BLUETOOTH™ specification”). The U.S. Pat. No. 5,940,431; the U.S. application Ser. Nos. 08/685,069; 08/932,911; and 08/932,244; and the “BLUETOOTH™ specification are each hereby incorporated herein by reference in their entireties.

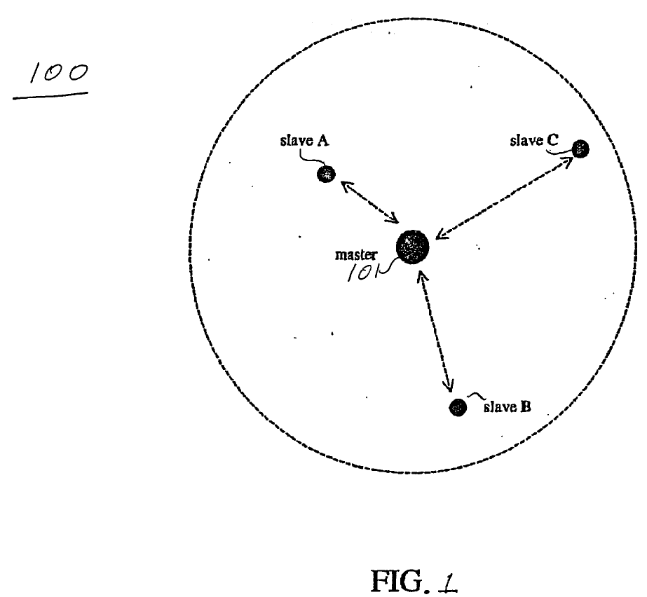

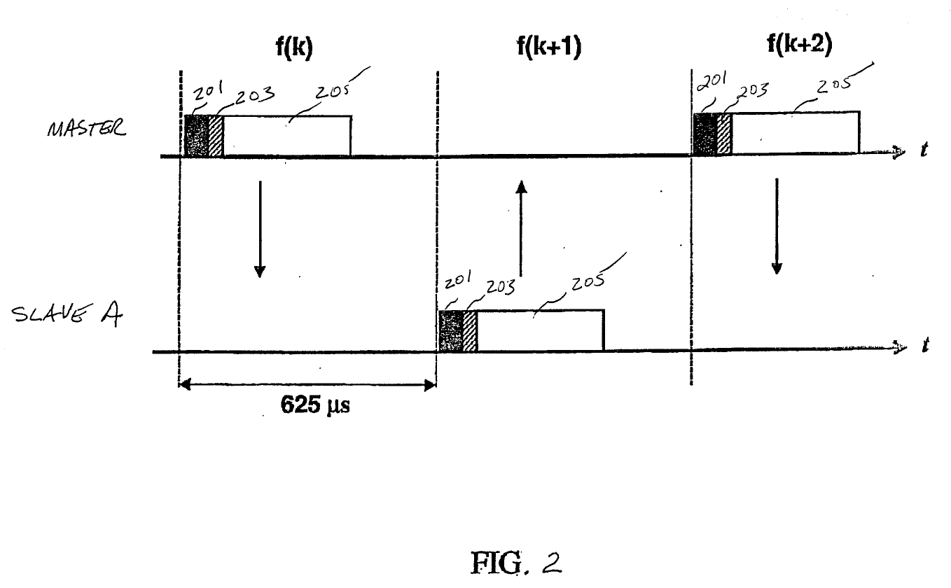

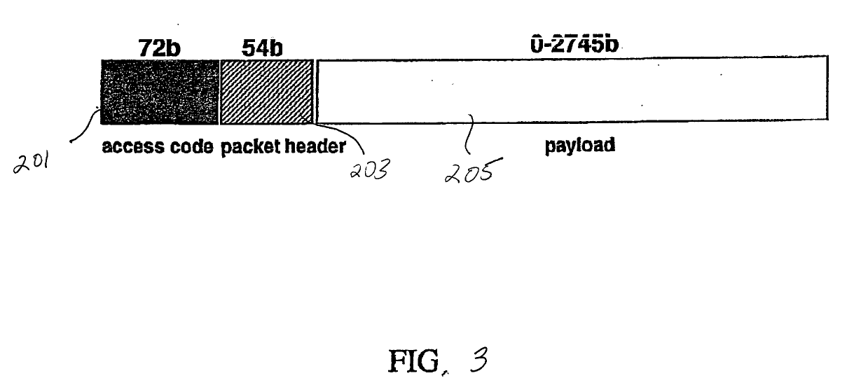

The considered air interface describes a physical interface where the transceiver alternately transmits and receives to support a duplex link, that is, in a so-called time-division duplex mode of operation. Time is divided into time slots (also referred to herein simply as “slots”) with, in an exemplary embodiment, a slot duration of 625 μs. Each time slot is associated with a different hop frequency according to a pseudo-random hop pattern. As a result, the hop rate corresponds to 1600 hops/s. The hop pattern is determined by the identity of one of the units participating in the link. This unit, which can be an arbitrary unit, is assigned the master role. The remaining units are slave units. The phase in the hop pattern is determined by the native system clock of this master unit. During connection setup, the identity and clock value are transferred from the master unit to the slave so that both can use the same hopping pattern and phase and thus stay in synchrony. The master and one or more slaves form a piconet which is a star network with the master controlling the traffic. An exemplary piconet 100 is depicted in FIG. 1. In the example, a master 101 forms a piconet with slaves A, B, and C. The information over the hopping piconet channel is transferred by means of short packets. The packets are alternatively transmitted from one unit to the other unit and vice versa. The flow of information from a master unit (MASTER) to a slave unit A in an exemplary frequency hopping/time-division duplex channel (called Time Division Duplexing) is illustrated in FIG. 2. Since each slot (k, k+1, k+2, . . . ) is on a different frequency, the channel is actually a Frequency Hop/Time Division Duplex (FH/TDD) channel. Let us define the transmission by the master as being on a forward link and the transmission from the slave being on a reverse link. Note that by alternatively transmitting and receiving, only half of the capacity is allocated to the forward link and the other half is allocated to the reverse link. Each packet contains a preamble (access code) 201, a header 203, and possibly a payload 205. One exemplary packet is illustrated in greater detail in FIG. 3. The preamble 201 contains a unique binary code identifying the piconet. The header 203 contains control information for flow control and error control. In addition, it contains a 3-bit slave address. This slave address is used by the master to direct a particular packet to a particular slave. All slaves receive the packets sent by the master on the forward link; however, only the slave indicated by the slave address in the packet header 203 will accept this packet and process the payload 205. The slave address also automatically indicates which slave is allowed to respond to the master in the next slave-to-master slot. Thus, even if no payload is attached, the packet sent by the master in the master-to-slave slot implicitly polls the slave that is allowed to send in the slave-to-master slot just following.

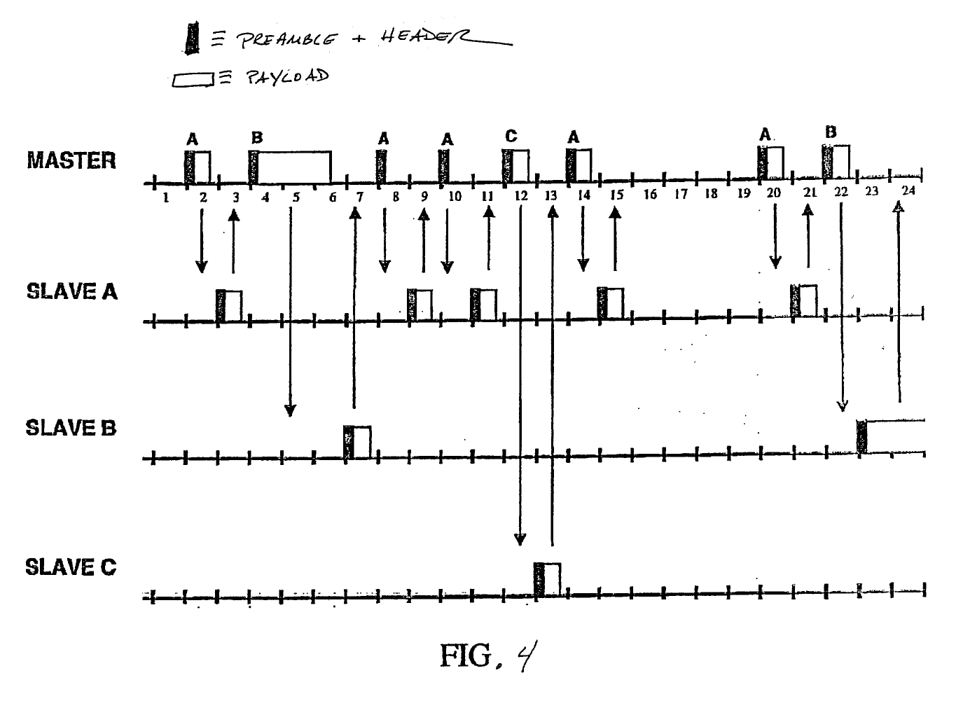

An example of this polling is shown in FIG. 4, in which a master communicates with three slaves (A, B and C). The master has complete control over which slave is being polled, and therefore has complete control over which slave can send information because a slave cannot transmit unless it is polled in the preceding slot. If the master has no information to send to the slave, it is preferable for the master still to occasionally poll the slave for the purpose of finding out whether the slave has information to send. In these instances, the master will send a packet having a preamble 201 and a header 203 containing the slave address, but not having a payload 205. In FIG. 4, this is the case in slots 8 and 10 where the master has nothing to send to slave A but still (implicitly) polls it. Polling and scheduling are considered the same in this context, and refer to the procedure in which the master addresses the slave for communications (either from master to slave, or from slave to master, or for both).

As mentioned in the Background section, under certain circumstances, such as in the communication of best effort data, it is difficult to know how to set the various parameters in the scheduling/polling algorithm. An improper parameter setting can have a serious negative effect. Moreover, the scheduling/polling algorithm presents added complexity. Also, a signaling-based solution may come at the expense of a very high overhead, and is not suitable for data applications which cannot make accurate predictions about their traffic requirements.

In order to address one or more of these and other issues, embodiments of the invention combine a contention-based medium access control strategy with the above-described polling strategy. More specifically, some slots are preassigned for use as a contention window, during which individual units may vie for access to the channel. Other slots, not preassigned for this use, may instead allocate access to the communication medium based on, for example, the polling strategy described above. These and other aspects of the invention will now be described in greater detail.

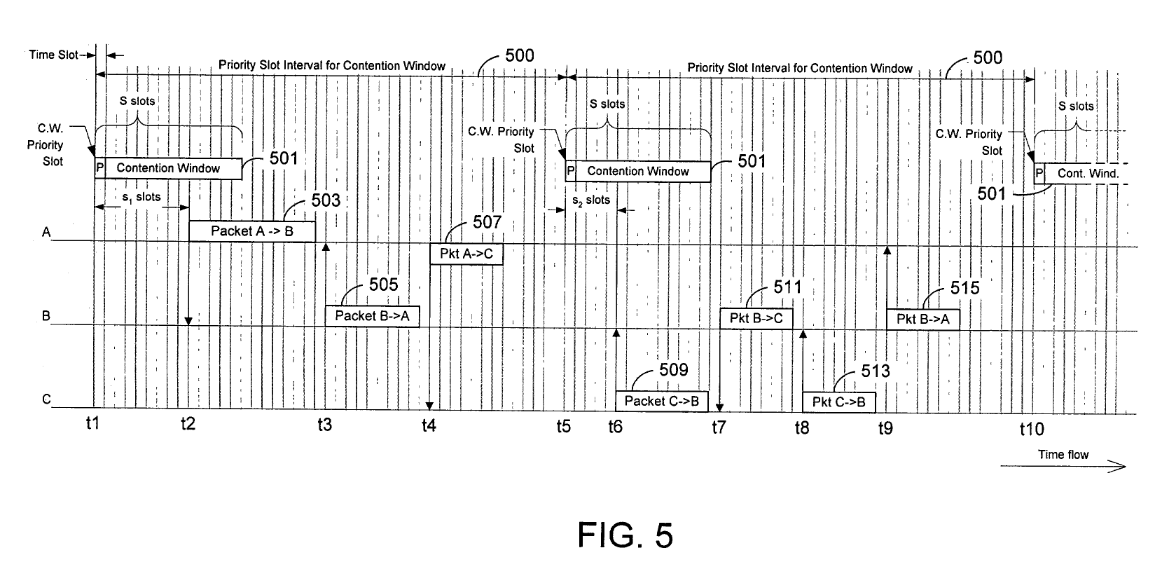

The overall behavior of an exemplary system in accordance with the invention will first be described with reference to FIG. 5. In one aspect of the invention, contention windows of time (henceforth referred to simply as “contention windows”) are defined to occur at predefined intervals of time 500. Each contention window 501 begins on a time slot boundary within the communications system and occupies a predefined number of slots, S. The first time slot occupied by the contention window 501 is designated as a contention window priority time slot, P. What this means is that, regardless of what other medium access control technique is being used at other times within the system (e.g., token passing), only a contention-based access strategy is used at the onset of the contention window 501.

Packet transmissions to and from three communication units, denoted A, B and C, are shown in the example of FIG. 5. A first contention window 501 begins at a time t1. Using a contention-based strategy (described in greater detail below), the communication unit A obtains the right to transmit a packet after a number, s₁, time slots have elapsed. In the illustration, this is shown as occurring at a time denoted t2. A more detailed description of the contention-based strategy for obtaining access to the communication medium is presented after the discussion of FIG. 5.

Having obtained the right to access the medium, communication unit A transmits a packet 503 to unit B. (Strictly speaking, what is illustrated in FIG. 5 might more accurately be referred to as a “frame” that comprises a number of packets in consecutive time slots. However, for simplicity of discussion, the term “packet” as used herein shall be construed to mean a group of one or more “single” packets that are intended to form a single unit and that are consecutively transmitted by a same sending communication unit to a same receiving communication unit.) The transmitted packet 503 (as well as all transmitted packets described herein) may occupy one or more communication time slots, the length being in accordance the communication system definition. One constraint on the length of any transmitted packet is that it cannot be so long that any portion of it would have to be transmitted in a time slot that has been preallocated for use by another communication device (i.e., a so-called “priority time slot”).

After receiving the packet 503 from communication unit A, the communication unit B responds, at time t3, by transmitting a packet 505 back to communication unit A. As illustrated in FIG. 5, there may be a one (or more) slot “gap” between the end of transmission of the packet 503 and the start of transmission of the packet 505. This gap may be required in some systems to act as a “guard interval” to ensure that the transmissions from two (or more) units do not overlap one another. (In other systems, there is no such gap, and consecutively occurring time slots are utilized by different communication units without interruption.) Because the inventive principles described herein are applicable regardless of whether or not a gap of one or more time slots is required between transmissions by different units, the term “useable time slot” shall be used to refer to only those time slots that are permitted to be used within a given system. Thus, for example in FIG. 5, the time slot beginning at time t3 is the “next useable time slot” following the end of transmission of the packet 503 because this exemplary system requires that a gap exist following completion of the transmission of the packet 503. That is, the physical time slot immediately preceding the time slot at time t3 is not “useable” by any of the communication units, and therefore cannot be considered a “next useable time slot” following completion of transmission of the packet 503. Of course, in systems not requiring any such gap, a “next useable time slot” following transmission of a packet by one entity could very well be the very next successive physical time slot. Furthermore in some systems, what constitutes a “next useable time slot” may vary depending on circumstances. For example, in the exemplary embodiment depicted in FIG. 5, the next useable time slot following the s₁ time slots beginning at time t1 is the time slot immediately beginning at time t2 (i.e., no gap is required by the protocol under these conditions), whereas the next useable time slot following transmission of the packet 503 doesn't begin until time t3 (i.e., a gap is required between transmissions under these circumstances).

The decision to transmit a packet from communication unit A to communication unit B at time t3 may be the result of any of a number of alternative strategies. In one alternative, the communication unit B may be constrained by the contention-based access strategy to respond to the communication unit from which it has just received a packet. Alternatively, the communication unit A may be acting as a master in the communication system, with the communication unit B acting as a slave. In this case, the transmission of the packet 505 to unit A may be in accordance with a protocol that requires each slave to respond to the master immediately after having received a packet from the master.

In yet another alternative, when not operating under a contention based strategy, communication units may utilize a token-based protocol, whereby a communication unit is permitted to transmit only when it is in possession of a (possibly virtual) token. In the example of FIG. 5, packet B will have received such a token by virtue of receipt of the packet 503 from communication unit A. In such a case, the token protocol governs to whom the communication unit B should transmit at time t3; in the example, this happens to be the communication unit A.

At time t4, which is the next useable time slot following transmission of the packet 505, the communication unit A transmits a packet 507 to communication unit C. Communication unit A's authority to transmit at this time may derive from any of a number of system designs, such as (but not limited to) its status as a master in a master-slave type of communication system, or alternatively as a result of possession of the token (passed from communication unit B to communication unit A at time t3). Of importance for purposes of this example is that the communication of the packet 507 from communication unit A to communication unit B at time t4 is not governed by the contention-based strategy, which is only in effect during those predefined times when a contention window 501 occurs.

Continuing with a description of the example, the communication unit C is not shown transmitting any packet during the interval that occurs after receipt of the packet 507 but before the occurrence of the next contention window 501 at time t5. This may be, for example, because the communication unit C did not have any packets for transmission that were short enough to be fully communicated prior to the occurrence of the next contention window 501, which had been scheduled to begin at time t5.

At time t5, another contention window 501 occurs. In the example, communication unit C contends for the right to access the medium, and wins this right after a number, s₂, time slots. Consequently, at time t6 the communication unit C transmits a packet 509 to the communication unit B. At time t7, which is the next useable time slot following transmission of the packet 509, the communication unit B responds by transmitting a packet 511 back to the communication unit C. This may be for any of the exemplary reasons discussed above with reference to the packet 505 that was transmitted at time t3.

At time t8, which is the next useable time slot following transmission of the packet 511, the communication unit C transmits a packet 513 back to communication unit B. This may be for any of the reasons explained above with respect to the transmission of packet 507 at time t4. Essentially, the unit C at time t8 is not operating under the constraints imposed by the contention-based protocol, which is only associated with an occurrence of the contention window 501.

At time t9, which is the next useable time slot following transmission of the packet 513, communication unit B transmits a packet 515 to communication unit A. Communication unit B's right to transmit at this time may derive, for example, from possession of a token either implicitly or explicitly passed from communication unit C with the packet 513. Communication unit B's selection of communication unit A as the recipient of a packet can be in accordance with any of a number of known selection priority strategies, descriptions of which go beyond the scope of this invention.

Time t10 marks the beginning of another contention window 501, and hence the occurrence of another interval during which a contention based medium access control strategy is in effect.

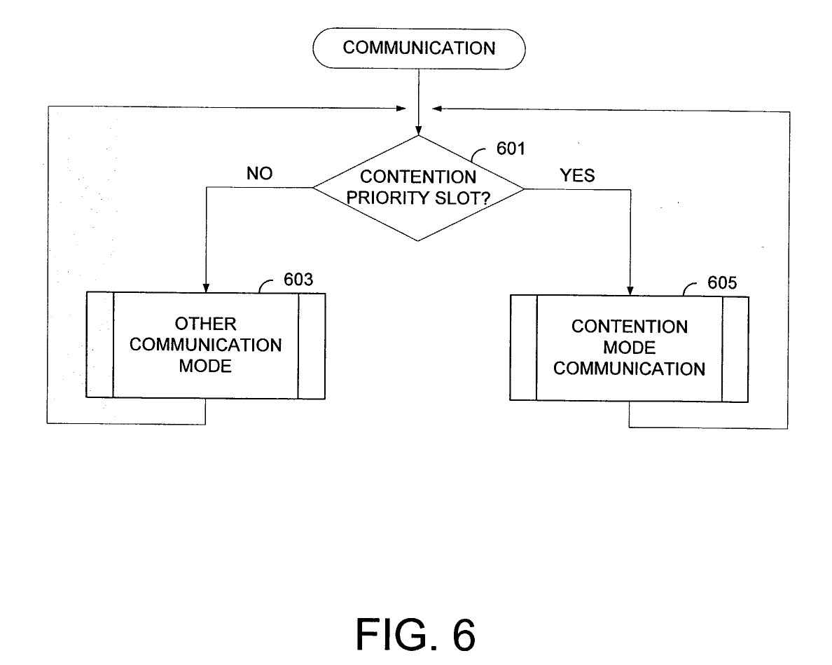

The invention will now be described in greater detail from the point of view of an exemplary communication unit operating in the communication system. Turning first to FIG. 6, this is a high-level flowchart of repetitive processes carried out in one or more communication units operating within the system. These one or more communication units together constitute a “contention group”. At the top of the loop, it is determined whether the present time slot is a contention window priority slot (step 601). If it is not (“NO” path out of decision block 601), then access to the medium in this time slot is governed by another of one or more other medium access control strategies being employed by the communication system. For example, access to the medium might be in accordance with a master-slave protocol (e.g., such as in BLUETOOTH™ 1.x systems). Alternatively, access to the communication medium might be governed by a token-based protocol. In yet another alternative, the time slot may be a so-called “priority time slot”, that has been preallocated for use only by a predetermined one of the communication units operating within the system. Combinations of these and other strategies may also be used. The particular “other communication mode” employed in any one embodiment is application specific, and beyond the scope of this description.

After the other communication mode is employed, the process continues back at decision block 601, where it is repeated for the new present time slot.

Returning to decision block 601, if it is determined that the present time slot is a contention window priority time slot (“YES” path out of decision block 601), then a contention-based medium access control strategy is employed (step 605). Following the communication that occurs in accordance with the contention-based medium access control strategy, the process continues back at decision block 601, where it is repeated for the new present time slot.

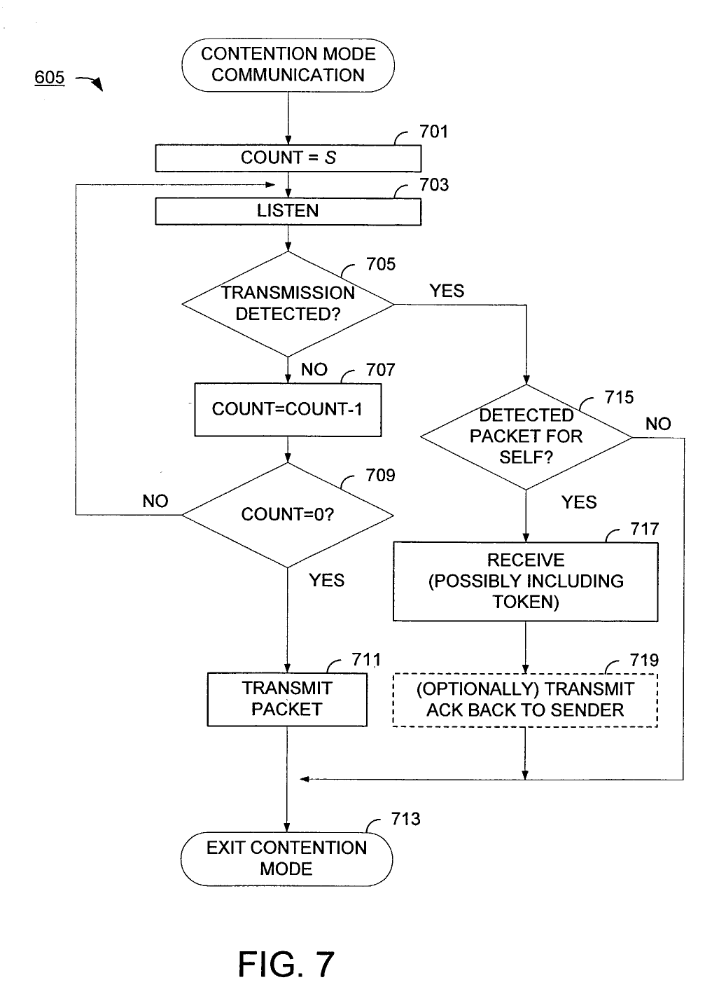

FIG. 7 is a flowchart of steps carried out by each of one or more communication units participating in the contention-based mode of communication, in accordance with an aspect of the invention. In the following discussion, the term “present communication unit” is used to refer to a communication unit that carries out the described steps. Other terms, such as but not limited to “another communication unit” and “other communication units” refer to communication units other than the “present communication unit.” The term “each communication unit” means those communication units that make up the contention group, including the present communication unit as well as other communication units.

First, the present communication unit initializes a count parameter, COUNT, to a value, s, which represents the maximum number of time slots that will be listened to before the present communication unit concludes that it may access the communication medium (step 701).

The value of s may be different in alternative embodiments of the invention. In one embodiment, s may simply be equal to zero. In another alternative s may be equal to one.

In yet another alternative, each communication unit independently assigns a random (or pseudorandom) number in the range [0 . . . S_{MAX}] to its value of COUNT.

Using a random (or pseudorandom) number may be more universally useful. However, in many embodiments it will most often be the case that different communication units will have data pending to be transmitted at different times; that is, for any given time slot, it is very likely that only one communication unit will want access to the communication medium. Under such conditions, it is wasteful to make a communication unit wait for a possibly lengthy amount of time before trying to access the communication unit. Therefore, in these systems it may be advantageous to use a fixed value for s, such as s=0, or s=1, as described above.

In yet another embodiment, a hybrid strategy is adopted, in which a fixed value of s is used initially by the communication unit, but if the communications medium is found not to be free (i.e., another communication unit is already accessing the communication medium) or if an RTS/CTS strategy is employed and the communication unit does not obtain access to the communication medium after a first attempt (this is discussed in detail later in this description), then for this transmission the communication unit switches to the use of a random (or pseudorandom) value of s, as described above. To facilitate understanding of other aspects of the invention, in the following discussion it is assumed that a non-hybrid embodiment is being implemented. It will be understood, however, that in a hybrid embodiment, additional steps would be used to modify the value of s for use in a retry of a transmission.

Having assigned an initial value to COUNT, the routine enters a loop in which the present communication unit will listen to the communication medium for up to s time slots to determine if any other communication unit has obtained access to the medium. If not, then the present communication unit will assume that the communication medium is free to use. More specifically, the present communication unit first listens to the communication medium (step 703). In carrying out this step, some embodiments may have the present communication unit listen at only the beginning of the slot, since this may be adequate to determine if the communication medium is free. During the remainder of the time, the present communication unit can save power by entering, for example, an idle mode.

If no transmission by another communication unit is detected (“NO” path out of decision block 705), then the COUNT parameter is adjusted (e.g., by decrementing it by 1) (step 707), and the COUNT value is tested. In this embodiment, the COUNT value is compared with zero; if the COUNT is not equal to zero (“NO” path out of decision block 709), it means that the present communication unit has not waited at least s time slots. Consequently, the routine jumps back to repeat the loop another time, beginning at step 703.

If the COUNT value does eventually reach a value of zero without any transmission having been detected (“YES” path out of decision block 709), then the present communication unit assumes that the medium is free and so transmits a packet (step 711) beginning at the next useable time slot. The details of how to employ a contention based strategy to access a communication medium are generally known, and need not be described here in greater detail. After successfully transmitting the packet, the present communication unit has completed the contention mode communication (step 713) and then returns to the top of the main loop that governs communication (i.e., step 601 in FIG. 6).

Returning to the discussion of decision block 705, if at some point during the first s slots the present communication unit detects a transmission associated with another one of the communication units (“YES” path out of decision block 705), then it knows that it did not win access to the communication medium during this contention window 501. Instead, the present communication unit determines (decision block 715) whether the transmitted packet is for itself, or whether it is alternatively directed to another one of the communication units. If the transmitted packet is directed to the present communication unit (“YES” path out of decision block 715), then it receives the packet (step 717). Depending on the particular embodiment, receipt of a packet may explicitly or implicitly give the present communication unit a token, and along with it the right to transmit by means of the communication medium in the next useable time slot. In such embodiments, the present communication unit may employ a priority strategy to determine to whom it will transmit in the next useable time slot.

In alternative embodiments, the recipient of the packet (step 717) is not free to communicate with the communication unit of its choosing. Instead, it is required by the contention-based communication strategy, to transmit, in the next useable time slot, an acknowledgment (ACK) back to the sender of the received packet (step 719).

Execution then exits the contention-based medium access mode (step 713), and returns to the top of the main loop that governs communication (i.e., step 601 in FIG. 6).

A number of alternative embodiments will now be described, each using the principles set forth in the above-described illustrative embodiments. To begin with, in the above-described embodiments, contention windows 501 were defined as occurring only at predetermined time slots (e.g., separated by predefined intervals of time 500). However, in alternative embodiments, contention windows 501 can also be permitted to occur at other times, such as starting at a next useable time slot immediately following a contention-based access of the communication medium. In fact, this and other alternatives are possible after a packet sent by a communication unit A in accordance with a contention-based protocol has been received by a communication unit B. These alternatives include:

1. The communication unit B can be granted the right to send anything to any communication unit in the system in the next useable time slot.

2. The communication unit B can be obligated to send an acknowledgment (ACK) back to the communication unit A in the next useable time slot.

3. The communication unit A can retain the right to transmit packets in the next useable time slot, either to the communication unit B or to any other communication unit in the system.

4. A third communication unit, C, can have the right to access the communication medium in the next useable time slot. For example, communication unit C might be the unit that last possessed a token just prior to the occurrence of the contention window 501.

5. The communication unit B can be granted the right to transmit any packet (i.e., not limited to ACK) in the next useable time slot, but only to the original communication unit A.

6. Any node in the contention group may consider that another contention window 501 has begun in the next useable time slot, and so may begin contending for the right to access the communication medium in accordance with the access protocol described above.

7. Allocation of the communication medium can be defined for two consecutively occurring “next useable time slots.” In a first of these useable time slots, the communication unit B can be obligated to send an acknowledgment (ACK) back to the communication unit A. In the second of these consecutively occurring useable time slots, any node in the contention group may consider that another contention window 501 has begun, and so may begin contending for the right to access the communication medium in accordance with the access protocol described above.

It is possible for a system to support different ones of these (and possibly other) alternatives at different times. One possibility for such support is to have an indication in a packet header that instructs which alternative will be followed next. Another possibility is for the selected alternative to be the result of negotiation on a per node basis.

Another group of alternative embodiments differ from those described earlier in that access to the communication medium is not granted merely on the basis of being the first communication unit to attempt transmission during the contention window 501. Rather, access is granted based on the use of two control messages: Request to Send (RTS) and Clear to Send (CTS). These are short messages that include the following information:

Source and destination address; and

An indication of how long the communication unit wants to use the communication medium. This can, for example, be expressed in terms of the size (e.g., number of slots, or bytes plus modulation) of the outgoing transmit queue in the communication unit.

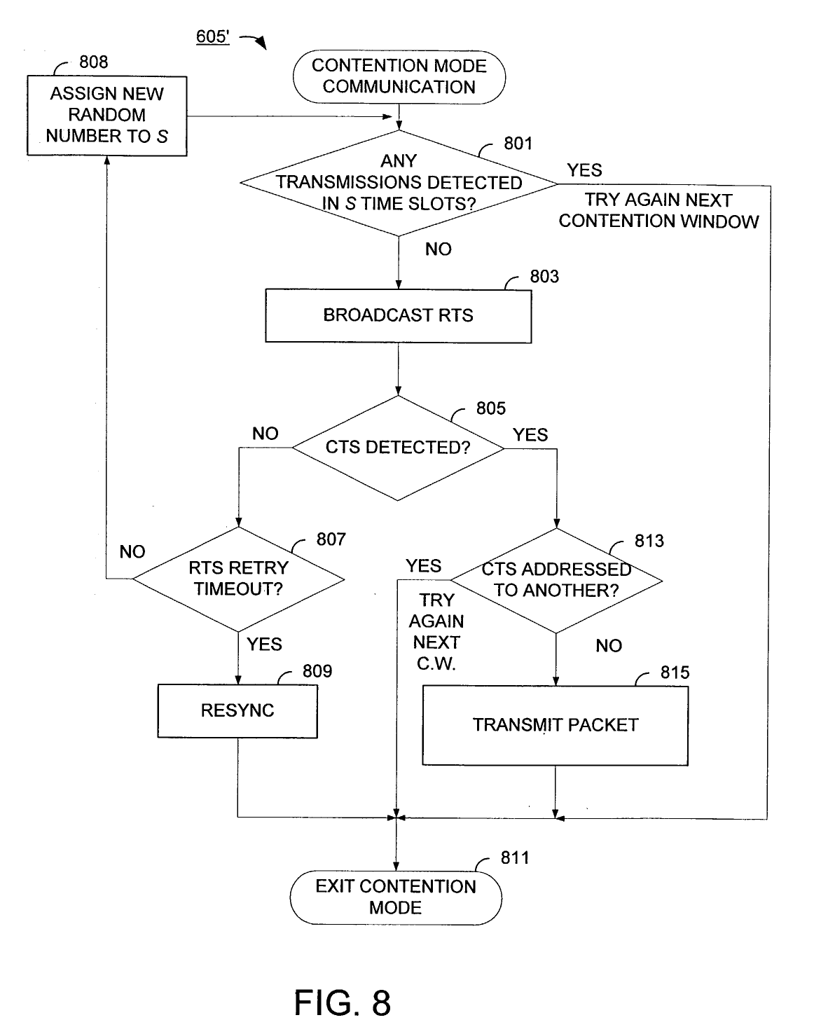

For these alternatives, the steps carried out in the contention mode communication (step 605 depicted in FIG. 6) are different from those set forth above with respect to that earlier-described embodiment. FIG. 8 is a flowchart of steps carried out in these alternatives (referred to as step 605′ to distinguish this class of embodiments from those described earlier). Starting at the beginning of a contention window 500, each member of the contention group that wishes to transmit a packet first listens to the communication medium for up to s time slots in order to determine whether any other communication unit is accessing the medium (decision block 801). If any other access is detected during these s time slots (“YES” path out of decision block 801), then the present communication unit will have to try to gain access during a next contention window (step 811).

If the present communication unit does not detect any other accesses during the s time slots (“NO” path out of decision block 801), then it broadcasts an RTS (step 803). The RTS serves several functions. First, it informs the intended recipient of the data of the desired transmission. The intended recipient should then confirm reception of the RTS by transmitting a CTS. The RTS also serves to inform other communication units (i.e., not the intended recipients of the data) that a data transfer will occur and that they should refrain from accessing the communication medium during the relevant time slots.

The intended recipient's transmitted CTS also serves to inform other communication units (i.e., not the intended recipients of the data) that a data transfer will occur and that they should refrain from accessing the communication medium during the relevant time slots. This redundancy is useful because it is quite possible that the other communication units did not receive the RTS. That is, they may be too far from the present communication unit to hear the RTS, but near enough to the intended recipient of the data to hear the CTS.

Having transmitted an RTS, the present communication unit next waits to see if it detects a CTS (decision block 805). If no CTS has been detected (“NO” path out of decision block 805), the present communication unit next determines whether an RTS retry timeout has occurred (decision block 807). This can be implemented, for example, by initializing a timer (not shown) to a suitable value (for the given communications system) prior to executing the loop defined by blocks 803, 805 and 807, and then testing the value of timer as execution of the loop progresses.

If no RTS retry timeout has occurred (“NO” path out of decision block 807), then the present communication unit backs off while listening. By “backing off while listening” is meant that the present communication unit selects a new random (or pseudorandom) value of s (step 808), and then repeats the loop, beginning at step 803. The effect of this is that the RTS/CTS procedure will be retried after the (new) s time slots, assuming that no other communication is detected during this time period. It is useful to increase the maximum possible value of s (i.e., to increase Sₘₐₓ, for example by doubling it) when assigning a new value of s, in order to reduce the risk that there will be another clash between communication units broadcasting an RTS during the same time slot. (Such clashes are very often the cause for the failure of the first attempt to obtain access to the communications medium.)

Returning now to decision block 807, if an RTS retry timeout has occurred (“YES” path out of decision block 807), then it is assumed that the present communication unit's clock is no longer synchronized with that of the radio network. Consequently, a resynchronization (“resync”) procedure is performed (step 809). An exemplary resync procedure is described in the BLUETOOTH™ High Rate Mode draft specification, which is used to resynchronize a present communication unit's clock to the common clock of the piconet. Resync procedures are generally known, and may vary from one network to another. For this reason, a detailed description of such a procedure is beyond the scope of this invention. Following the resync procedure, the contention mode process is exited (step 811).

Returning now to decision block 805, if a CTS is detected (“YES” path out of decision block 805), then the present communication unit determines whether the CTS is addressed to another node (i.e., a node other than the present communication unit) (decision block 813). If not (“NO” path out of decision block 813), then the present communication unit has been granted access to the communications medium. Consequently, it transmits a packet (step 815) to the recipient of its choice. Following this, the contention mode process is exited (step 811).

If it is determined that the detected CTS is addressed to another node (“YES” path out of decision block 813), then the present communication unit has not been granted access to the communications medium. Consequently, it will have to try again for access when the next contention window 501 occurs. The contention mode process is simply exited at this point (step 811).

If at any time in the procedure above, for example during the back-off period that is entered from the “NO” path out of decision block 807, the present communication unit receives an RTS addressed to it, it may take on the responder's role and send a CTS to the source of the RTS, in accordance with the algorithm.

The various embodiments described above provide significant advantages over other medium access control strategies while still providing a very flexible and simple distributed implementation. Power consumption is reduced because:

Communication units need only to activate their receivers at high-rate slot boundaries (and for the duration of sent headers);

The contention window is limited bot in size and when it occurs in time; and

Communication units are free to set their own duty cycle on which contention windows and priority slots to listen on.

Embodiments of the invention can also address the so-called “hidden node” problem. This is a problem that can occur when three or more communication units are participating in a piconet, and positioned such that a second communication unit can hear and communicate with both a first and third of the communication units, but one or both of the first and third communication units cannot hear the other one; for example, the third communication unit cannot hear the first communication unit. In this case, the first communication unit is “hidden” from the third communication unit. This is problematic because a communication unit may attempt to utilize the communications medium at the same time as the hidden communication unit. The resultant interference may mean that neither of the communication units (e.g., the first and third) are able to successfully communicate their packets.

This problem is addressed by using the RTS/CTS-related embodiments described above. The RTS/CTS exchange makes it likely that communication units will hear at least one of the communication units taking part in the data transaction. In the example described in the previous paragraph, this means that the third communication unit will at least hear the second communication unit's CTS, responsive to an RTS transmitted by the “hidden” first communication unit. In this way, the third communication unit can at least indirectly learn of the existence of the first communication unit.

In other embodiments, the “hidden node” problem can be completely avoided by slightly extending the RTS/CTS scheme (in a compatible manner) using a central repeater that repeats the access granting CTS. This would enable every communication unit in the piconet to learn about the existence of all others that have been granted access to the communications medium.

For example, the central unit can be defined as a unit that can be heard by all or most of the relevant units in the network. In one embodiment, the repeating central unit marks the received CTS with a predefined flag. The flag ensures that the repeated CTS will not be an exact copy of, and therefore cannot be mistaken for, the original CTS. The original unit that sent the RTS waits for a predefined period of time after having received the original CTS (i.e., the one without the flag), in order to permit the central unit to access the communication medium with its transmission of the repeated CTS.

In other embodiments, the principles involved in the above-described procedure with the repeated CTS can alternatively (or in conjunction with the repeated CTS) be applied in the other direction for the RTS; that is, the central unit repeats the RTS (marked as copy by means of, for example, a flag). This, however, is less efficient.

In yet other embodiments, the central unit can be implemented such that if it receives multiple RTSs, it decides which unit will get access to the medium by sending the appropriate CTS.

Another advantage of the invention is that, for specific nodes with very specific requirements, for example, on high-priority synchronous streamed traffic, a non-contention based access scheme can still be implemented in a manner that is completely compatible and transparent to the contention based access method described above. For example, other priority slots can be defined as occurring on one or more slots not occupied by the contention window 501.

The invention has been described with reference to a particular embodiment. However, it will be readily apparent to those skilled in the art that it is possible to embody the invention in specific forms other than those of the preferred embodiment described. This may be done without departing from the spirit of the invention.

For example, the above-described polling procedure has been optimized for the BLUETOOTH™ air interface. Of course, the same procedures can be used by other systems that similarly apply time slot-based medium access control mechanisms.

Thus, the above-described embodiments are merely illustrative and should not be considered restrictive in anyway. The scope of the invention is given by the appended claims, rather than the preceding description, and all variations and equivalents which fall within the range of the claims are intended to be embraced therein.

What is claimed is:

1. A method of accessing a communication medium by a present communication unit in a communications system, wherein the communication medium comprises a plurality of successively occurring time slots, the method comprising:
determining whether a present time slot is a contention priority slot;
if the present time slot is a contention priority slot, then using a contention-based medium access control protocol to access the communication medium; and
if the present time slot is not a contention priority slot, then using a non-contention-based medium access control protocol to access the communication medium.

2. The method of claim 1, wherein the non-contention-based protocol comprises:
determining whether the present time slot is a priority time slot owned by the present communication unit; and
if the present time slot is the priority time slot owned by the present communication unit, then transmitting a packet from the present communication unit.

3. The method of claim 1, wherein the non-contention-based protocol comprises:
transmitting a packet from the present communication unit only if the present communication unit owns a token.

4. The method of claim 1, wherein:
the present communication unit is a slave unit in the communications system; and
the non-contention-based protocol comprises transmitting a packet to a master unit in the communications system only if the slave unit was addressed by the master unit in an earlier time slot preceding the present time slot.

5. The method of claim 1, wherein the contention-based protocol comprises:
listening to at least a portion of each of a number, s, of time slots to determine whether any of one or more other communication units has utilized the communication medium; and
if no other communication unit has utilized the communication medium during any of the s time slots, then transmitting in a first next useable time slot a packet from the present communication unit to any other communication unit in the communications system.

6. The method of claim 5, wherein the contention-based protocol further comprises:
after transmitting, in the first next useable time slot, the packet from the present communication unit to any other communication unit in the communications system, transmitting, in a second next useable time slot following the first next useable time slot, another packet to any other communication unit in the communications system.

7. The method of claim 1, wherein the contention-based protocol comprises:
listening to at least a portion of each of one or more of a number, s, of time slots to determine whether any of one or more other communication units has utilized the communication medium; and
if another communication unit has utilized the communication medium during any of the s time slots, then further performing the steps of:
determining whether the utilization of the communication medium by said another communication unit has been directed to the present communication unit; and
if the utilization of the communication medium by said another communication unit has been directed to the present communication unit, then transmitting an acknowledgment from the present communication unit to said another communication unit in a first next useable time slot.

8. The method of claim 7, wherein the contention-based protocol further comprises:
if the utilization of the communication medium by said another communication unit has been directed to the present communication unit, then after transmitting the acknowledgment from the present communication unit to said another communication unit in the first next useable time slot, using the contention-based medium access control protocol to access the communication medium in a second next useable time slot following the first next useable time slot.

9. The method of claim 1, wherein the contention-based protocol comprises:
listening to at least a portion of each of one or more of a number, s, of time slots to determine whether any of one or more other communication units has utilized the communication medium; and
if another communication unit has utilized the communication medium during any of the s time slots, then further performing the steps of:
determining whether the utilization of the communication medium by said another communication unit has been directed to the present communication unit; and
if the utilization of the communication medium by said another communication unit has been directed to the present communication unit, then transmitting in a next useable time slot, by the present communication unit, a packet to said another communication unit or to any other communication unit in the communications system.

10. The method of claim 1, wherein the contention-based protocol comprises:
listening to at least a portion of each of one or more of a number, s, of time slots to determine whether any of one or more other communication units has utilized the communication medium; and
if another communication unit has utilized the communication medium during any of the s time slots, then further performing the steps of:
determining whether the utilization of the communication medium by said another communication unit has been directed to the present communication unit; and
if the utilization of the communication medium by said another communication unit has not been directed to the present communication unit, then transmitting, by the present communication unit in a next useable time slot, a packet to said another communication unit or to any other communication unit in the communications system.

11. The method of claim 1, wherein the contention-based protocol comprises:
listening to at least a portion of each of one or more of a number, s, of time slots to determine whether any of one or more other communication units has utilized the communication medium; and
if another communication unit has utilized the communication medium during any of the s time slots, then further performing the steps of:
determining whether the utilization of the communication medium by said another communication unit has been directed to the present communication unit; and
if the utilization of the communication medium by said another communication unit has been directed to the present communication unit, then transmitting a packet from the present communication unit to said another communication unit in a next useable time slot.

12. The method of claim 1, wherein the contention-based protocol comprises:
listening to at least a portion of each of one or more of a number, s, of time slots to determine whether any of one or more other communication units has utilized the communication medium; and
if the utilization of the communication medium by said another communication unit has been directed to the present communication unit or to another communication unit, then using the contention-based medium access control protocol to access the communication medium in a next useable time slot.

13. The method of claim 1, wherein the contention-based protocol comprises:
transmitting on the communication medium, by the present communication unit, a request to send;
detecting that a clear to send has been transmitted by another communication unit in the communications system; and
transmitting a packet from the present communication unit in response to determining that the detected clear to send is directed to the present communication unit.

14. The method of claim 1, wherein the contention-based protocol comprises:
transmitting on the communication medium, by the present communication unit, a request to send;
detecting that another request to send has been transmitted by another communication unit, wherein said another request to send is directed to the present communication unit;
transmitting by the present communication unit a clear to send to said another communication unit, thereby allocating the communication medium to said another communication unit for use in a next useable time slot.

15. The method of claim 1, wherein:
the present communication unit is a central unit in the communications system; and
the contention-based protocol comprises:
detecting a request to send that has been transmitted by another communication unit; and
broadcasting a copy of the detected request to send.

16. The method of claim 15, wherein the detected request to send is not directed to the present communication unit.

17. The method of claim 15, wherein the copy of the detected request to send is distinguishable from the detected request to send.

18. The method of claim 15, wherein the central unit is a communication unit that can be heard by at least most of the communication units in the communication system.

19. The method of claim 1, wherein:
the present communication unit is a central unit in the communications system; and
the contention-based protocol comprises:
detecting a clear to send that has been transmitted by another communication unit; and
broadcasting a copy of the detected clear request to send.

20. The method of claim 19, wherein the copy of the detected clear to send is distinguishable from the detected request to send.

21. The method of claim 19, wherein the central unit is a communication unit that can be heard by at least most of the communication units in the communication system.

22. The method of claim 1, wherein:
the present communication unit is a central unit in the communications system; and
the contention-based protocol comprises:
detecting a plurality of request to sends that have been transmitted by a corresponding plurality of other communication units;
generating a clear to send; and
broadcasting the generated clear to send.

23. The method of claim 22, wherein the detected plurality of request to sends are not directed to the present communication unit.

24. The method of claim 22, wherein the central unit is a communication unit that can be heard by at least most of the communication units in the communication system.

25. An apparatus for accessing a communication medium by a present communication unit in a communications system, wherein the communication medium comprises a plurality of successively occurring time slots, the apparatus comprising:
logic that determines whether a present time slot is a contention priority slot;
logic that uses a contention-based medium access control protocol to access the communication medium if the present time slot is a contention priority slot; and
logic that uses a non-contention-based medium access control protocol to access the communication medium if the present time slot is not a contention priority slot.

26. The apparatus of claim 25, wherein the logic that uses the non-contention-based protocol comprises:
logic that determines whether the present time slot is a priority time slot owned by the present communication unit; and
logic that transmits a packet from the present communication unit if the present time slot is the priority time slot owned by the present communication unit.

27. The apparatus of claim 25, wherein the logic that uses the non-contention-based protocol comprises:
logic that transmits a packet from the present communication unit only if the present communication unit owns a token.

28. The apparatus of claim 25, wherein:
the present communication unit is a slave unit in the communications system; and
the logic that uses the non-contention-based protocol comprises logic that transmits a packet to a master unit in the communications system only if the slave unit was addressed by the master unit in an earlier time slot preceding the present time slot.

29. The apparatus of claim 25, wherein the logic that uses the contention-based protocol comprises:
logic that listens to at least a portion of each of a number, s, of time slots to determine whether any of one or more other communication units has utilized the communication medium; and
logic that transmits, in a first next useable time slot, a packet from the present communication unit to any other communication unit in the communications system if no other communication unit has utilized the communication medium during any of the s time slots.

30. The apparatus of claim 29, wherein the logic that uses the contention-based protocol further comprises:
logic that transmits, in a second next useable time slot following the first next useable time slot, another packet to any other communication unit in the communications system.

31. The apparatus of claim 25, wherein the logic that uses the contention-based protocol comprises:
logic that listens to at least a portion of each of one or more of a number, s, of time slots to determine whether any of one or more other communication units has utilized the communication medium; and
logic that, if another communication unit has utilized the communication medium during any of the s time slots, further performs:
determining whether the utilization of the communication medium by said another communication unit has been directed to the present communication unit; and
transmitting an acknowledgment from the present communication unit to said another communication unit in a next occurring time slot if the utilization of the communication medium by said another communication unit has been directed to the present communication unit.

32. The apparatus of claim 31, wherein the logic that uses contention-based protocol further comprises:
logic that, after transmitting the acknowledgment from the present communication unit to said another communication unit in the first next useable time slot, uses the contention-based medium access control protocol to access the communication medium in a second next useable time slot following the first next useable time slot.

33. The apparatus of claim 25, wherein the logic that uses the contention-based protocol further comprises:
logic that listens to at least a portion of each of one or more of a number, s, of time slots to determine whether any of one or more other communication units has utilized the communication medium; and
logic that, if another communication unit has utilized the communication medium during any of the s time slots, performs:
determining whether the utilization of the communication medium by said another communication unit has been directed to the present communication unit; and
logic that transmits in a next useable time slot, by the present communication unit, a packet to said another communication unit or to any other communication unit in the communications system if the utilization of the communication medium by said another communication unit has been directed to the present communication unit.

34. The apparatus of claim 25, wherein the logic that uses the contention-based protocol further comprises:
logic that listens to at least a portion of each of one or more of a number, s, of time slots to determine whether any of one or more other communication units has utilized the communication medium; and
logic that, if another communication unit has utilized the communication medium during any of the s time slots, performs:
determining whether the utilization of the communication medium by said another communication unit has been directed to the present communication unit; and
transmitting, by the present communication unit in a next useable time slot, a packet to said another communication unit or to any other communication unit in the communications system if the utilization of the communication medium by said another communication unit has not been directed to the present communication unit.

35. The apparatus of claim 25, wherein the logic that uses the contention-based protocol further comprises:
logic that listens to at least a portion of each of one or more of a number, s, of time slots to determine whether any of one or more other communication units has utilized the communication medium; and
logic that, if another communication unit has utilized the communication medium during any of the s time slots, performs:
determining whether the utilization of the communication medium by said another communication unit has been directed to the present communication unit; and
transmitting a packet from the present communication unit to said another communication unit in a next useable time slot if the utilization of the communication medium by said another communication unit has been directed to the present communication unit.

36. The apparatus of claim 25, wherein the logic that uses the contention-based protocol further comprises
logic that listens to at least a portion of each of one or more of a number, s, of time slots to determine whether any of one or more other communication units has utilized the communication medium; and
logic that uses the contention-based medium access control protocol to access the communication medium in a next useable time slot if the utilization of the communication medium by said another communication unit has been directed to the present communication unit or to another communication unit.

37. The apparatus of claim 25, wherein the logic that uses the contention-based protocol comprises:
logic that transmits on the communication medium, by the present communication unit, a request to send;
logic that detects that a clear to send has been transmitted by another communication unit in the communications system; and
logic that transmits a packet from the present communication unit in response to determining that the detected clear to send is directed to the present communication unit.

38. The apparatus of claim 25, wherein the logic that uses the contention-based protocol comprises:
logic that transmits on the communication medium, by the present communication unit, a request to send;
logic that detects that another request to send has been transmitted by another communication unit, wherein said another request to send is directed to the present communication unit;
logic that transmits by the present communication unit a clear to send to said another communication unit, thereby allocating the communication medium to said another communication unit for use in a next useable time slot.

39. The apparatus of claim 25, wherein:
the present communication unit is a central unit in the communications system; and
the logic that uses the contention-based protocol comprises:
logic that detects a request to send that has been transmitted by another communication unit; and
logic that broadcasts a copy of the detected request to send.

40. The apparatus of claim 39, wherein the detected request to send is not directed to the present communication unit.

41. The apparatus of claim 39, wherein the copy of the detected request to send is distinguishable from the detected request to send.

42. The apparatus of claim 39, wherein the central unit is a communication unit that can be heard by at least most of the communication units in the communication system.

43. The apparatus of claim 25, wherein:
the present communication unit is a central unit in the communications system; and
the logic that uses the contention-based protocol comprises:
logic that detects a clear to send that has been transmitted by another communication unit; and
logic that broadcasts a copy of the detected clear request to send.

44. The apparatus of claim 43, wherein the copy of the detected clear to send is distinguishable from the detected request to send.

45. The apparatus of claim 43, wherein the central unit is a communication unit that can be heard by at least most of the communication units in the communication system.

46. The apparatus of claim 25, wherein:
the present communication unit is a central unit in the communications system; and
the logic that uses the contention-based protocol comprises:
logic that detects a plurality of request to sends that have been transmitted by a corresponding plurality of other communication units;
logic that generates a clear to send; and
logic that broadcasts the generated clear to send.

47. The apparatus of claim 46, wherein the detected plurality of request to sends are not directed to the present communication unit.

48. The apparatus of claim 46, wherein the central unit is a communication unit that can be heard by at least most of the communication units in the communication system.

49. A method of controlling access to a communication medium between two or more terminals in a network, wherein the communication medium comprises a plurality of successively occurring time slots, the method comprising:
in each of a sequence of contention windows occurring over time in a fixed or variable time interval, using a contention-based access protocol to allocate access to the communication medium by one of the two or more terminals; and
in remaining time slots of the communication medium not included within any of the contention windows, using a non-contention based access protocol to allocate access to the communication medium by one of the two or more terminals.

50. An apparatus for controlling access to a communication medium between two or more terminals in a network, wherein the communication medium comprises a plurality of successively occurring time slots, the apparatus comprising:
logic that, in each of a sequence of contention windows occurring over time in a fixed or variable time interval, uses a contention-based access protocol to allocate access to the communication medium by one of the two or more terminals; and
logic that, in remaining time slots of the communication medium not included within any of the contention windows, uses a non-contention based access protocol to allocate access to the communication medium by one of the two or more terminals.
